(19) United States
(12) Patent Application Publication
(10) Pub. No.: US 2024/0335861 A1
(43) Pub. Date: Oct. 10, 2024

(54) STEREOSCOPIC SORTING CONTROL METHOD, STEREOSCOPIC SORTING ROBOT, AND RELATED DEVICE

(71) Applicant: Zhejiang Libiao Robotics Co., Ltd., Hangzhou, Zhejiang (CN)

(72) Inventors: Huiling XIA, Zhejiang (CN); Jianqiang ZHU, Zhejiang (CN); Juejing XU, Zhejiang (CN); Ming MA, Zhejiang (CN)

(21) Appl. No.: 18/293,149

(22) PCT Filed: Mar. 31, 2022
(86) PCT No.: PCT/CN2022/084624

§ 371 Date: Jan. 29, 2024

(30) Foreign Application Priority Data
Aug. 11, 2021 (CN) 202110919357.X

(51) Int. Cl. B07C 5/36; B25J 9/16

(52) U.S. Cl. CPC B07C 5/361; B25J 9/1697; B07C 2301/0016

(57) ABSTRACT

A stereoscopic sorting control method, a stereoscopic sorting robot, and a related device. The stereoscopic sorting control method comprises: stereoscopic sorting robots having a binding relationship with identity information of target sorting shelves, wherein the binding relationship is associated with a target order; under a sorting task of the target order, the stereoscopic sorting robots sorting, according to the identity information of the sorting shelves, goods to be sorted; when a first stereoscopic sorting robot has a fault, unbinding the first stereoscopic sorting robot and the target sorting shelves; acquiring state information of other stereoscopic sorting robots, wherein the state information indicates that a second stereoscopic sorting robot is in an available and idle state; and rebinding the second stereoscopic sorting robot with the target sorting shelves.

### CROSS-REFERENCE TO RELATED APPLICATIONS

The present disclosure claims the priority to the Chinese patent application with the filling No. 202110919357.X filed with the Chinese Patent Office on Aug. 11, 2021, and entitled “STEREOSCOPIC SORTING CONTROL METHOD, STEREOSCOPIC SORTING ROBOT, AND RELATED DEVICE”, the contents of which are incorporated herein by reference in entirety.

### TECHNICAL FIELD

The present disclosure relates to the technical field of sorting robots, and in particular to a stereoscopic sorting control method, a stereoscopic sorting robot, and a related device.

### BACKGROUND ART

A sorting robot, equipped with sensors and identification mechanisms, capable of executing sorting actions, is used for rapidly sorting goods. The existing sorting robots are divided into platform-type sorting robots or sorting robotic arms. In distribution centers, parcels are placed from bags onto the conveyor belt. Upon reaching the position of the corresponding sorting bag at the destination, the sorting is completed by making the parcels drop down or grabbing the parcels from the conveyor belt and putting them into the sorting bag at the destination.

The current flat sorting systems, once deployed, can efficiently handle sorting tasks. However, stereoscopic sorting systems offer improved sorting efficiency and are increasingly applied. For the current stereoscopic sorting systems, the problem of not being able to quickly solve the faults has become a hindrance to the application and the promotion.

The embodiments of the present disclosure provide a stereoscopic sorting control method, stereoscopic sorting robot, and related device to achieve the technical objectives of improving sorting efficiency and enabling rapid maintenance of faults.

A stereoscopic sorting control method for a stereoscopic sorting system is provided, wherein system can include multiple stereoscopic sorting robots and sorting shelves, wherein the stereoscopic sorting control method can include:
the stereoscopic sorting robots having a binding relationship with the identity information of target sorting shelves, wherein the binding relationship can be associated with a target order; under a sorting task of the target order, the stereoscopic sorting robots sorting, according to the identity information of the sorting shelves, goods to be sorted;
when a first stereoscopic sorting robot has a fault, unbinding the first stereoscopic sorting robot and the target sorting shelves;
acquiring state information of other stereoscopic sorting robots, when the state information indicates that a second stereoscopic sorting robot is in an available and idle state;
and rebinding the second stereoscopic sorting robot with the target sorting shelves.

Optionally, the stereoscopic sorting system can further include one or more flat sorting robots, wherein the flat sorting robots can perform goods delivery to the first stereoscopic sorting robot based on the target order; and
when the first stereoscopic sorting robot has a fault, the method can further include:
controlling the flat sorting robots to abandon the goods delivery to the first stereoscopic sorting robot;
determining that the target order is re-associated with a rebinding relationship between the second stereoscopic sorting robot and the target sorting shelves; and
controlling the flat sorting robots to initiate the goods delivery to the second stereoscopic sorting robot based on the target order.

Optionally, the step of acquiring state information of other stereoscopic sorting robots can include:
determining the operational state information and health state information of multiple stereoscopic sorting robots, wherein the operational state information can include, but is not limited to, idle state, in-use state, and standby state; the health state information can include, but is not limited to, fault state, available state, and test state;
determining that the operational state information of a stereoscopic sorting robot is the idle state, and its health state information is the available state, using it as an alternative robot for the second stereoscopic sorting robot; and
selecting the optimal robot from multiple alternative stereoscopic sorting robots to serve as the second stereoscopic sorting robot.

Optionally, after rebinding the second stereoscopic sorting robot with the target sorting shelves, the stereoscopic sorting control method can further include:
acquiring the sorting state when the first stereoscopic sorting robot has a fault, wherein the sorting state can include incomplete sorting of the target sorting shelves and incomplete unloading of baskets of the target sorting shelves;
when the target sorting shelves are not completely sorted, binding the second stereoscopic sorting robot with the target sorting shelves; and
when the unloading of baskets of the target sorting shelves is not completed, placing the goods with incomplete unloading onto the second stereoscopic sorting robot.

Optionally, the step of controlling the flat sorting robots to abandon the goods delivery to the first stereoscopic sorting robot includes:
the flat sorting robots responding to the fault signal of the first stereoscopic sorting robot acquired by the flat dispatch system;
pausing the goods delivery to the first stereoscopic sorting robot; and
walking along a predetermined path until the binding between the second stereoscopic sorting robot and the target sorting shelves is completed.

Optionally, the stereoscopic sorting robots can have a binding relationship with the identity information of target sorting shelves, wherein the identity information of target sorting shelves is realized by the stereoscopic sorting robot using RFID readers, which can include:
reading the labels arranged on the target sorting shelves to obtain the identity information, wherein the labels can carry structural data of the sorting shelves and/or location information of the basket units, wherein:
the structural data of the sorting shelves indicates the longitudinal and transverse structure of the sorting shelves and information about available baskets; and
the location information of the basket units indicates the positions of the basket units in the coordinate system formed by the sorting shelves.

Optionally, the step of stereoscopic sorting robots sorting, according to the identity information of the sorting shelves, goods to be sorted, can include:
parsing the sorting information of the goods to be sorted, wherein the sorting information carries a corresponding relationship with a basket unit in the sorting shelves;
searching the corresponding relationship table to obtain the coordinate values of the basket unit in the stereoscopic coordinate system formed by the sorting shelves; and
indexing the coordinate value and locating, to deliver the goods to be sorted to the basket unit.

Optionally, the stereoscopic sorting system can further include a control bus, and the step of acquiring state information of other stereoscopic sorting robots can include:
acquiring state information of other stereoscopic sorting robots on the control bus.

A stereoscopic sorting robot is provided, wherein the stereoscopic sorting robot can be configured in the stereoscopic sorting system and can have a binding relationship with identity information of target sorting shelves, and the binding relationship can be associated with a target order. Under a sorting task of the target order, the stereoscopic sorting robots sort, according to the identity information of the sorting shelves, goods to be sorted;
when a first stereoscopic sorting robot has a fault, the first stereoscopic sorting robot can unbind with the target sorting shelves;
the server acquires state information of other stereoscopic sorting robots, when the state information indicates that a second stereoscopic sorting robot is in an available and idle state; and
the second stereoscopic sorting robot can rebind with the target sorting shelves.

Optionally, the stereoscopic sorting system can further include one or more flat sorting robots, wherein the flat sorting robots can perform goods delivery to the first stereoscopic sorting robot based on the target order;
when the first stereoscopic sorting robot has a fault, the flat sorting robots can abandon the goods delivery to the first stereoscopic sorting robot and periodically interrogate the state of the target order; and
when the target order is re-associated with a rebinding relationship between the second stereoscopic sorting robot and the target sorting shelves,
the second stereoscopic sorting robot accepts goods delivery from the flat sorting robots based on the target order.

Optionally, in the operational state information and health state information of multiple stereoscopic sorting robots, the operational state information can include, but is not limited to, idle state, in-use state, and standby state; and the health state information can include but is not limited to, fault state, available state, and test state, wherein:
when the operational state information of a stereoscopic sorting robot is the idle state and health state information is the available state, the stereoscopic sorting robot is used as an alternative robot for the second stereoscopic sorting robot; and
a predetermined rule is used to select the optimal robot from multiple alternative stereoscopic sorting robots to serve as the second stereoscopic sorting robot.

Optionally, the stereoscopic sorting robots can have a binding relationship with the identity information of target sorting shelves, wherein the identity information of target sorting shelves can be realized by the stereoscopic sorting robot using RFID readers in the following method:
reading the labels arranged on the target sorting shelves to obtain the identity information, wherein the labels can carry structural data of the sorting shelves and/or location information of the basket units, wherein:
the structural data of the sorting shelves indicates the longitudinal and transverse structure of the sorting shelves and information about available baskets; and
the location information of the basket units indicates the position of the basket units in the coordinate system formed by the sorting shelves.

Optionally, the stereoscopic sorting robot can be arranged in the stereoscopic sorting system via a bus structure.

A stereoscopic sorting control system, wherein the system can be configured in the stereoscopic sorting system,
and the stereoscopic sorting control system can perform the stereoscopic sorting control method described above.

Optionally, the system can perform through a server the aforementioned stereoscopic sorting control method in the stereoscopic sorting control system.

Optionally, the stereoscopic sorting control system can be provided with a host computer or central controller to allocate sorting tasks to the stereoscopic sorting robot.

A computing device, including:
at least one processor; and
a memory communicatively connected to the at least one processor, wherein:
the memory stores instructions that can be executed by the at least one processor, and the instructions are executed by the at least one processor to enable the at least one processor to perform the stereoscopic sorting method as described above.

Disclosed in the present disclosure are a stereoscopic sorting control method, a stereoscopic sorting robot, and a related device. The method includes when a first stereoscopic sorting robot has a fault, unbinding the first stereoscopic sorting robot and the target sorting shelves; acquiring state information of other stereoscopic sorting robots, wherein the state information indicates that a second stereoscopic sorting robot is in an available and idle state; and rebinding the second stereoscopic sorting robot with the target sorting shelves. Therefore, after the stereoscopic sorting robots have a fault, existing idle robots that operate normally are used to rapidly participate in sorting, thereby achieving the technical aim of improving the overall sorting efficiency.

### BRIEF DESCRIPTION OF DRAWINGS

The drawings depicted herein are provided to offer a further understanding of the present disclosure and constitute a part of the present disclosure. The illustrative embodiments and their descriptions serve to explain the present disclosure and do not constitute undue limitations on the present disclosure. In the drawings:

FIG. 1a is a schematic diagram of the structure of a stereoscopic sorting system in the embodiment of the present disclosure;

FIG. 1b is a schematic diagram of the structure of stereoscopic sorting shelves in the embodiment of the present disclosure;

FIG. 1c is a schematic diagram of the structure of the stereoscopic sorting shelves in the embodiment of the present disclosure;

FIG. 1d is a flowchart of the process of the stereoscopic sorting control method in the embodiment of the present disclosure;

FIG. 2 is a flowchart of the process of the stereoscopic sorting control method in the embodiment of the present disclosure;

FIG. 3 is a flowchart of the process of the stereoscopic sorting control method in the embodiment of the present disclosure;

FIG. 4 is a flowchart of the process of the stereoscopic sorting control method in the embodiment of the present disclosure;

FIG. 5 is a flowchart of the process of the stereoscopic sorting control method in the embodiment of the present disclosure;

FIG. 6 is a schematic diagram of the execution process based on a stereoscopic sorting robot in the embodiment of the present disclosure;

FIG. 7 is a structural schematic diagram of the stereoscopic sorting system in the embodiment of the present disclosure;

FIG. 8 is a structural schematic diagram of the computing device in the embodiment of the present disclosure; and

FIG. 9 is a structural schematic diagram of the readable medium in the embodiment of the present disclosure.

### DETAILED DESCRIPTION OF EMBODIMENTS

The embodiments of the present disclosure provide a stereoscopic sorting control method, stereoscopic sorting robot, and related device to achieve the technical objectives of improving sorting efficiency and enabling rapid maintenance of faults.

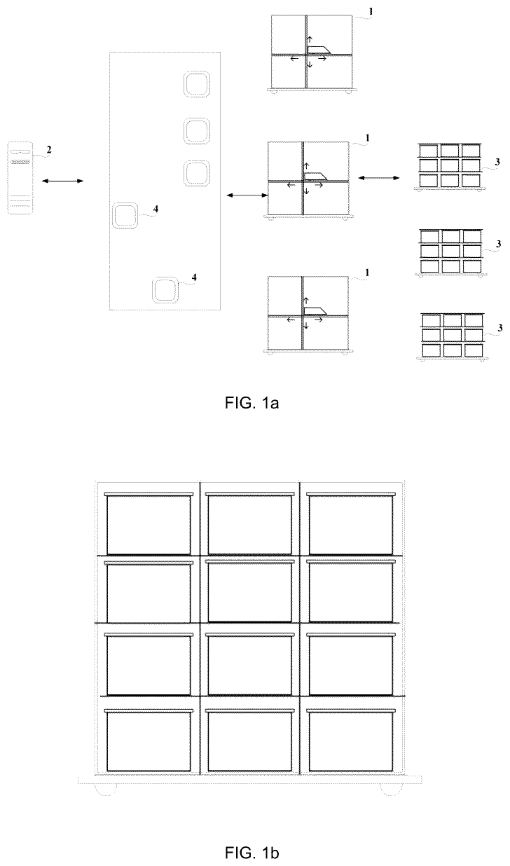

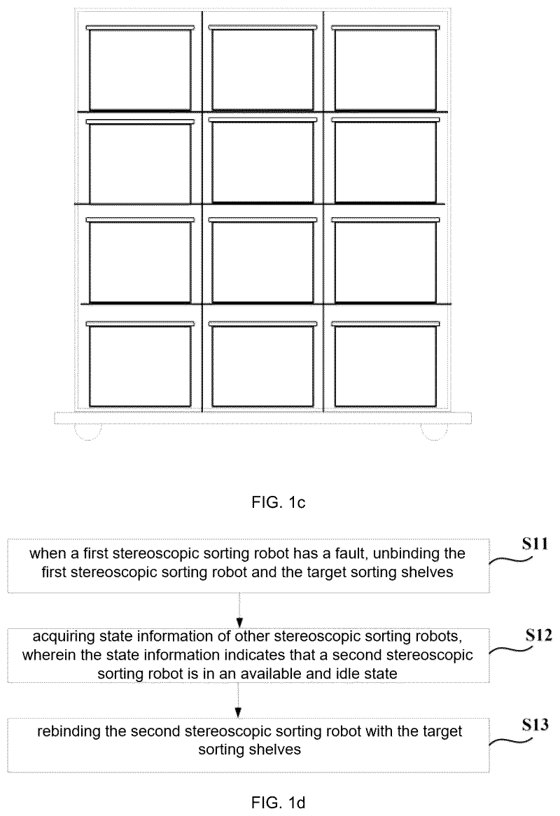

For ease of understanding, illustration for the embodiment of the present disclosure is based on the structure shown in FIG. 1a, but this does not imply that the structure shown in FIG. 1a limits the scope of the present disclosure.

In conjunction with FIG. 1a, the following description is given for the stereoscopic sorting system provided by the embodiments of the present disclosure. In the present disclosure, multiple stereoscopic sorting robot 1, a server 2, and sorting shelves 3 are provided. As an optional embodiment, stereoscopic sorting robot 1 is provided and mounted in the sorting region in an active manner through a bus (such as CAN). The sorting shelves are in contacted communication with the stereoscopic sorting robots. Of course, it is also possible to achieve data exchange through wireless means without physical contact. This is not limited herein. The stereoscopic sorting robot 1 can be provided with a support frame structure and use lateral motion mechanism and vertical motion mechanism to identify the sorting shelves having multi-layered stereoscopic structures and execute sorting tasks. At the same time, the stereoscopic sorting robot 1 can be provided with a flipping board or a structure assembly for putting goods into the sorting shelves. It can collaborate with desktop sorting robots or flat sorting robots 4 for sorting tasks based on some batch order. The server 2 is configured to control sorting batches, sorting orders, and multiple stereoscopic sorting robots within the local area network or region. It also establishes the binding relationships between the stereoscopic sorting robots and the sorting shelves, which is specifically the binding for a particular batch and order. In the present disclosure, the server can utilize wired or wireless methods to complete the control and the state interrogation of each sorting robot in the stereoscopic sorting system, which includes but is not limited to bus control methods.

Referring to FIG. 1b-1c, in the present disclosure, the sorting shelves can be sorting shelves or baskets of any structure or shape. Conventional sorting shelves or baskets are configured based on different products or sorting lines. The structures of sorting shelves are not uniform, which even are composed of multiple shelves joined together.

Based on this, with reference to FIG. 1d, the stereoscopic sorting control method in the present disclosure includes:
stereoscopic sorting robots having a binding relationship with the identity information of target sorting shelves, wherein the binding relationship is associated with a target order; and under a sorting task of the target order, the stereoscopic sorting robots sorting, according to the identity information of the sorting shelves, goods to be sorted. It should be noted that, in the sorting task of a specific order A002, the order A002 has sorting tasks of 10,000 pieces. The stereoscopic sorting robots, during the sorting process, need to be bound to the target sorting shelf 001 to accomplish precise sorting of the goods in the task order A002.

In a stereoscopic sorting system, a stereoscopic sorting shelf generally refers to a shelf structure with at least two or more layers. The shelves are regularly arranged with basket units. However, in the practical application of the sorting shelves in the present disclosure, specific structures and the number of layers is not limited. Referring to the illustration in FIG. 1c, in a stereoscopic sorting system, the number of the sorting shelves is multiple. For instance, the current target sorting shelf is labeled as 001, and its identity information includes at least the structural data of the sorting shelf. For instance, the structure of the sorting shelf 001 has 4 rows and 3 columns. After it is recognized by the stereoscopic sorting robots, the goods to be sorted need to be placed in the basket located at the 3rd row and 2nd column. The stereoscopic sorting robots only need to place the goods according to their structure and position. The structural data can also be differentiated based on the type of sorting shelf. For example, the X001 type refers to a rectangular sorting shelf with a structure of 4 rows and 3 columns, and the Y001 type refers to a rectangular sorting shelf with a structure of 8 rows and 5 columns.

S11: when a first stereoscopic sorting robot has a fault, unbinding the first stereoscopic sorting robot and the target sorting shelves.

In the embodiment, in the stereoscopic sorting system, multiple stereoscopic sorting robots simultaneously perform ordered sorting tasks under the control of the bus. When a certain stereoscopic sorting robot experiences a mechanical fault or a signal fault, it will send a fault feedback signal to the server. At this point, it is necessary to unbind the binding relationship between the first stereoscopic sorting robots and the target sorting shelves so as to enable the target sorting shelves to continue to complete the sorting task of the order.

Optionally, in a system controlled by coordination between the server and the CAN bus, the binding relationship between the first stereoscopic sorting robot and the sorting shelves is achieved by inserting the current shelf into the sorting robot workstation. Unbinding the binding relationship between the current shelf and the first stereoscopic sorting robot is achieved by pulling out the current shelf from the first stereoscopic sorting robot. It should be emphasized that this approach is a preferred one.

S12: acquiring state information of other stereoscopic sorting robots, wherein the state information indicates that a second stereoscopic sorting robot is in an available and idle state.

Due to the simultaneous participation of multiple stereoscopic sorting robots in sorting within the sorting region, the state of other stereoscopic sorting robots can be obtained by means of bus interrogation, including determining the operational state information and health state information of multiple stereoscopic sorting robots, wherein the operational state information includes, but is not limited to, idle state, in-use state, and standby state; and the health state information includes, but is not limited to, fault state, available state, and test state. To ensure the normal completion of orders, it is necessary to select stereoscopic sorting robots that are in an idle state and available state for the re-sorting of the target sorting shelves.

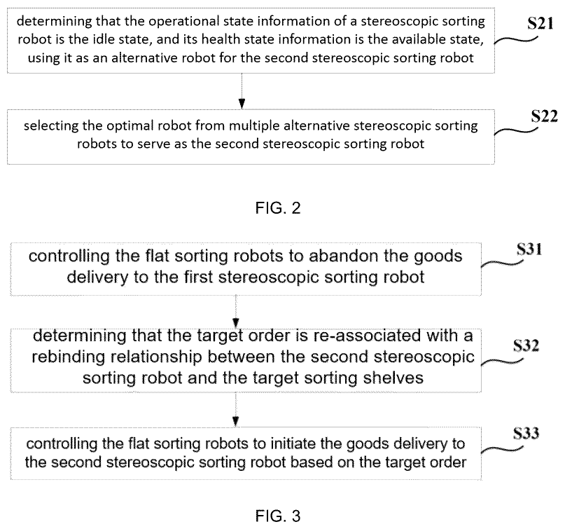

Referring to FIG. 2, when multiple stereoscopic sorting robots meet the criteria, the following steps are performed.

S21: determining that the operational state information of a stereoscopic sorting robot is the idle state, and its health state information is the available state, using it as an alternative robot for the second stereoscopic sorting robot.

S22: selecting the optimal robot from multiple alternative stereoscopic sorting robots to serve as the second stereoscopic sorting robot.

More specifically, among the multiple alternative stereoscopic sorting robots, the second stereoscopic sorting robot can be selected through the optimal path, optimal health status, etc. In a system controlled by coordination between the server and the CAN bus, the selection of the second stereoscopic sorting robot can be achieved by operators performing on-site selection on the second stereoscopic sorting robot for plug-in operation at the sorting region, thus completing the rebinding.

S13: rebinding the second stereoscopic sorting robot with the target sorting shelves.

After rebinding, the second stereoscopic sorting robot takes over to complete the sorting task of the first stereoscopic sorting robot and the target sorting shelves for the target order.

In the embodiment, on the server side, for managing and collecting data on batches, orders, and order completion situation, the server needs to store the identity information of each sorting shelf or basket in the embodiment. It also stores and updates the relationship between the stereoscopic sorting robots, the order executed, and the bound stereoscopic sorting shelf or basket (first sorting shelf and second sorting shelf).

Referring to FIG. 1a, in the stereoscopic sorting system of this solution, the sorting robots running in the plane are responsible for delivering the goods to be sorted to the sorting mechanism of the stereoscopic sorting robots. Additionally, one stereoscopic sorting system is configured with one or more flat sorting robots cooperating with the stereoscopic sorting robots, wherein the flat sorting robots perform goods delivery to the first stereoscopic sorting robot based on the target order.

Referring to FIG. 3, when the first stereoscopic sorting robot has a fault, the method further includes the following steps.

S31: controlling the flat sorting robots to abandon the goods delivery to the first stereoscopic sorting robot.

In the embodiments of the present disclosure, the server can be configured as needed and can be divided into an order server and a sorting server. The flat sorting robots transmit fault signals for the first stereoscopic sorting robot through the server. They cannot continue the delivery action to the first stereoscopic sorting robot under the target order.

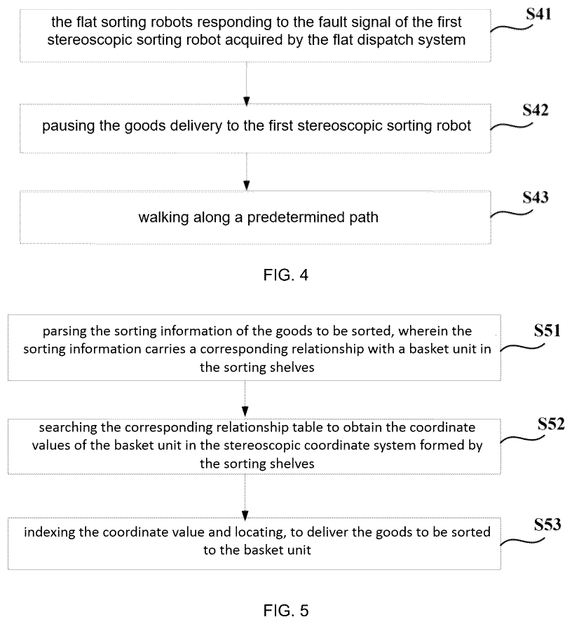

More specifically, FIG. 4 is referred to.

S41: the flat sorting robots responding to the fault signal of the first stereoscopic sorting robot acquired by the flat dispatch system.

The flat dispatch system centrally allocates and controls the flat sorting robots. The flat dispatch system can be embedded in the server or deployed in a separate server, which is not limited.

S42: pausing the goods delivery to the first stereoscopic sorting robot.

S43: walking along a predetermined path.

For example, five flat sorting robots PM001-PM005 perform delivery actions to the first stereoscopic sorting robot. However, when the first stereoscopic sorting robot has a fault, the flat sorting robots need to continue walking on the plane without performing delivery actions. The specific path can be walking in place or moving back and forth around a track, and it is not limited.

S32: determining that the target order is re-associated with a rebinding relationship between the second stereoscopic sorting robot and the target sorting shelves.

In this scenario, the flat sorting robots are interconnected with the vehicle server. When the vehicle server receives rebinding relationships from the order server, the flat sorting robots acquire instructions for continuing the target order. The instructions carry the order number of the target order, and the identity information, and the position information of the second stereoscopic sorting robot that has been rebound.

S33: controlling the flat sorting robots to initiate the goods delivery to the second stereoscopic sorting robot based on the target order.

The flat sorting robots PM001-PM005, in accordance with the execution sequence, recognize the identity information and position information of the second stereoscopic sorting robot and deliver the goods to be sorted to it.

For the first sorting robot and the second sorting robot, the principle of sorting is described as follows. Under the sorting task of the target order, the goods to be sorted are sorted according to the identity information of the shelf.

In the embodiment, the stereoscopic sorting robots need to follow the control of the server for the orders and sorting tasks that they are to complete. The sorting target for the stereoscopic sorting robots is goods, and the target positions are determined based on the identity information of the sorting shelves or baskets mentioned above.

In the embodiment, to acquire more detailed information about the sorting shelves, it further includes: acquiring attribute data of the basket units of the sorting shelves, including one or a combination of more of size data, volume data, and type data. For allocation of goods to be sorted into baskets for quick and appropriate sorting, it is necessary to acquire the dimensions, volume, and type of each basket unit for corresponding sorting task assignments.

Based on the attribute data, the goods to be sorted in the target order are matched, and a corresponding relationship table between the goods to be sorted and the basket units is generated.

Each of goods to be sorted has a corresponding relationship with one or more basket units based on the sorting task. The sorting robot completes precise sorting based on the corresponding relationship.

For the acquisition step in FIG. 1, the RFID can be configured for reading the labels arranged on the target sorting shelves to obtain the identity information, wherein the labels can carry structural data of the sorting shelves and/or location information of the basket units.

Certainly, the RFID tag cards configured on the target sorting shelf may only contain the ID of that target sorting shelf. Its structural data and/or the position information of the basket units can be stored on the server for acquisition by the stereoscopic sorting robots.

The structural data of the sorting shelves indicate the longitudinal and transverse structure of the sorting shelves and information about available baskets.

The location information of the basket units indicates the position of the basket units in the coordinate system formed by the sorting shelves.

The above-mentioned form of RFID reading is a preferred implementation for the active sorting shelves configured in the stereoscopic sorting system. When the sorting robot 001 receives the sorting task for a specific order A002, for efficiently completing the sorting, nine active sorting shelves (X010-X090) are assigned to the sorting robot 001 to complete the order.

When the active sorting shelf of type X001 is involved in sorting, the sorting robot 001 reads the RFID tag of the active sorting shelf X010. It reads that the target rectangular sorting shelf is of type X001 (X001 type is a rectangular sorting shelf with 4 rows and 3 columns). By reading, it is determined that the target sorting shelf has 12 available baskets with four horizontal ones and three vertical ones. When the target sorting shelf is divided based on the coordinate system, the 12 available baskets can be labeled as X1Y1 (1,1) representing the basket of first row and first column, X1Y2 (1,2) representing the basket of first row and second column, and so on, up to X4Y3 (4,3) representing the basket of fourth row and third column.

It is important to note that during the execution of the target order A002, the binding relationship between the stereoscopic sorting robot and the target sorting shelves is unique. In other words, the sorting robot 001 completes the sorting of the active sorting shelf X010 and then proceeds to the sorting of the active sorting shelf X020. Therefore, when the first sorting robot, i.e., sorting robot 001, has a fault and is unbound from the target sorting shelf, i.e., active sorting shelf X010, the second sorting robot, i.e., sorting robot 008, is selected to rebind with the active sorting shelf X010. It is then associated with the order A002 to continue the sorting process.

Referring to FIG. 5, the sorting step can be carried out by the following embodiment.

S51: parsing the sorting information of the goods to be sorted, wherein the sorting information carries a corresponding relationship with a basket unit in the sorting shelves.

S52: searching the corresponding relationship table to obtain the coordinate values of the basket unit in the stereoscopic coordinate system formed by the sorting shelves.

S53: indexing the coordinate value and locating, to deliver the goods to be sorted to the basket unit.

The above steps are based on the illustrations and examples provided for FIGS. 1 and 2. However, they are not limited to the method of using RFID to read identity information and finding corresponding relationship tables to complete the delivery of some goods to be sorted.

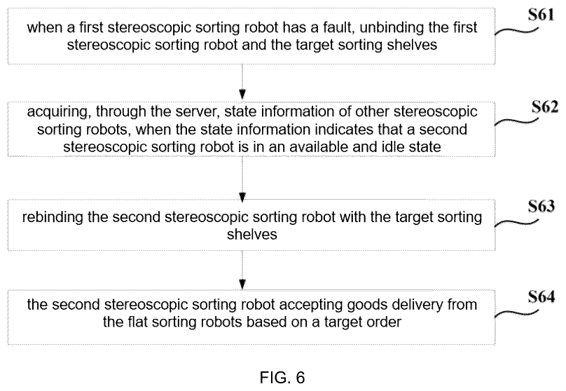

Referring to FIG. 6 and in conjunction with FIG. 1a, in the embodiments of the present disclosure, further disclosed is a stereoscopic sorting robot, configured in a stereoscopic sorting system (referring to the illustration in FIG. 1a) and having a binding relationship with identity information of target sorting shelves, wherein the binding relationship is associated with a target order. Under the sorting task of the target order, the goods to be sorted are sorted according to the identity information of the shelf.

S61: when a first stereoscopic sorting robot has a fault, unbinding the first stereoscopic sorting robot and the target sorting shelves.

Due to the simultaneous participation of multiple stereoscopic sorting robots in sorting within the sorting region, the stereoscopic sorting robots can be arranged in the stereoscopic sorting system via a bus structure. The state of other stereoscopic sorting robots can be obtained by server-to-bus interrogation.

Optionally, in a system controlled by coordination between the server and the CAN bus, the binding relationship between the current shelf and the sorting robot is achieved by inserting the current shelf into the sorting robot workstation. Unbinding the binding relationship between the current shelf and the sorting robot is achieved by pulling out the current shelf from the sorting robot. It should be emphasized that this approach is a preferred one.

The stereoscopic sorting robot 1 can be provided with a support frame structure and use lateral motion mechanism and vertical motion mechanism to identify the sorting shelves having multi-layered stereoscopic structures and execute sorting tasks. At the same time, the stereoscopic sorting robot 1 can be provided with a flipping board or a structure assembly for putting goods into the sorting shelves. Optionally, the stereoscopic sorting robots have a binding relationship with the identity information of target sorting shelves, wherein the identity information of target sorting shelves is realized by the stereoscopic sorting robot using RFID readers, specifically as follows. The labels arranged on the target sorting shelves are read to obtain the identity information, wherein the labels can carry structural data of the sorting shelves and/or location information of the basket units. The structural data of the sorting shelves indicates the longitudinal and transverse structure of the sorting shelves and information about available baskets. The location information of the basket units indicates the position of the basket units in the coordinate system formed by the sorting shelves.

The fault of the first sorting robot can be a mechanical fault or an electrical fault, such as an inability to perform delivery tasks normally, structural faults, or an inability to read the identity information of the sorting shelf.

S62: acquiring, through the server, state information of other stereoscopic sorting robots, when the state information indicates that a second stereoscopic sorting robot is in an available and idle state.

Optionally, in the operational state information and health state information of multiple stereoscopic sorting robots, the operational state information includes, but is not limited to, idle state, in-use state, and standby state; and the health state information includes but is not limited to, fault state, available state, and test state.

When the operational state information of a stereoscopic sorting robot is the idle state and health state information is the available state, the stereoscopic sorting robot is used as an alternative robot for the second stereoscopic sorting robot.

A predetermined rule is used to select the optimal robot from multiple alternative robots to serve as the second stereoscopic sorting robot.

S63: rebinding the second stereoscopic sorting robot with the target sorting shelves.

Optionally, the stereoscopic sorting system further includes one or more flat sorting robots, wherein the flat sorting robots perform goods delivery to the first stereoscopic sorting robot based on the target order.

When the first stereoscopic sorting robot has a fault, the flat sorting robots abandon the goods delivery to the first stereoscopic sorting robot and periodically interrogate the state of the target order.

The target order is re-associated with a rebinding relationship between the second stereoscopic sorting robot and the target sorting shelves.

S64: the second stereoscopic sorting robot accepting goods delivery from the flat sorting robots based on the target order.

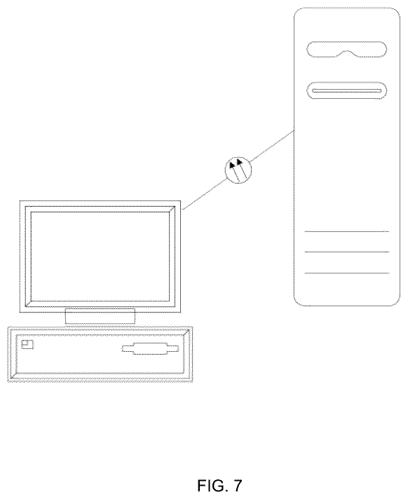

Referring to FIG. 7, a stereoscopic sorting control system is illustrated, and the system is configured in a stereoscopic sorting system.

The stereoscopic sorting control system executes the stereoscopic sorting control method as shown in FIGS. 1 to 5 and its corresponding stereoscopic sorting control method described above. The stereoscopic sorting control system can achieve control through one or multiple sets of servers. It can also be provided with a host computer or a central controller to complete the allocation of sorting tasks to the stereoscopic sorting robots. For specific control methods, the diagrams and explanations in FIGS. 1 to 5 are referred to; and further details are not repeated in the embodiment.

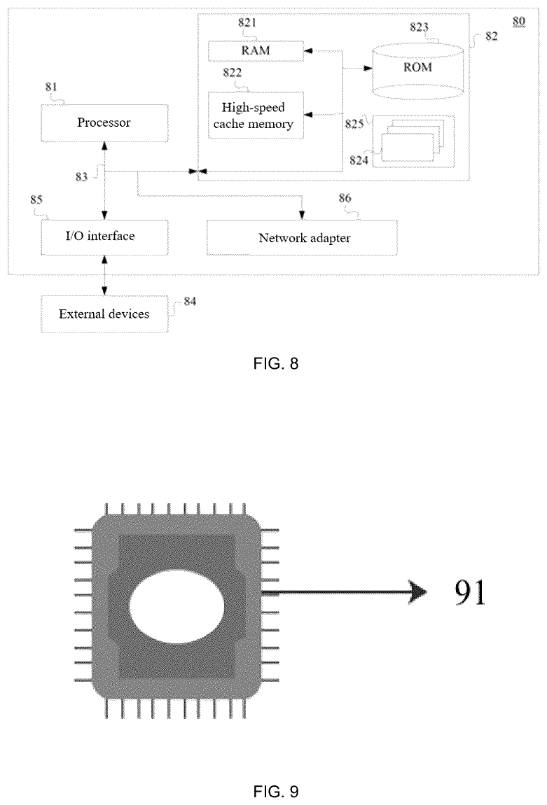

FIG. 8 illustrates the computing device 80 that corresponds to the methods shown in FIGS. 1 to 5, including the following components.

It should be noted that the computing device 80 shown in FIG. 8 is just an example and should not impose any limitations on the functionality and scope of use of the embodiments of the present disclosure.

As shown in FIG. 8, the server is represented in the form of a general-purpose computing device 80 as preferred. The components of the computing device 80 can include, but are not limited to, the aforementioned at least one processor 81, the aforementioned at least one memory 82, and a bus 83 connecting various system components, including the memory 82 and the processor 81.

The bus 83 represents one or more types of bus structures, including a memory bus or memory controller, a peripheral bus, a processor, or a local bus using any of a variety of bus structures.

The memory 82 can include volatile memory in the form of readable media, such as random access memory (RAM) 821 and/or high-speed cache memory 822, and can further include read-only memory (ROM) 823.

The memory 82 can also include program/application tool 825 having a set (at least one) of program modules 824. The program modules 824 include, but are not limited to an operating system, one or more application programs, other program modules, and program data. Each of these examples or any combination thereof can include an implementation in a network environment.

The computing device 80 can also communicate with one or more external devices 84 (such as a keyboard, pointing device, etc.) and can also communicate with one or more devices that allow a user to interact with computing device 80, and/or with any device that enables computing device 80 to communicate with one or more other computing devices (such as routers, modems, etc.). This communication can be facilitated through an input/output (I/O) interface 85. Additionally, the computing device 80 can communicate with one or more networks (e.g., local area network (LAN), wide area network (WAN), and/or public networks, such as the Internet) via a network adapter 88. As shown in the figure, the network adapter 88 communicates with other modules for computing device 80 via bus 83. It should be understood that, although not depicted in the figure, other hardware and/or software modules can be employed in conjunction with computing device 80, including but not limited to microcode, device drivers, redundant processors, external disk drive arrays, RAID systems, tape drives, and data backup storage systems, among others.

In some possible embodiments, the computing device according to the present disclosure can include at least one processor and at least one memory (such as the first server). The memory stores program code, and when the program code is executed by the processor, it causes the processor to perform the steps of the system privilege activation method described in various exemplary embodiments of the present disclosure as described in the summary.

Referring to FIG. 9, the stereoscopic sorting control method is depicted in FIGS. 1-5 and corresponding embodiments can also be implemented through a computer-readable medium 91. As shown in FIG. 9, it stores computer-executable instructions, i.e., program instructions required for the stereoscopic sorting control system in the present disclosure. The computer or high-speed chip can execute the instructions to perform the stereoscopic sorting control method described in the embodiments.

The readable signal medium can include data signals propagated in the baseband or as part of a carrier, carrying readable program code. The propagated data signals can take various forms, including but not limited to electromagnetic signals, optical signals, or any suitable combination thereof. The readable signal medium can also be any readable medium other than a readable storage medium, and the medium can send, propagate, or transmit programs for use or combination with instruction execution systems, devices, or equipment.

The program code contained on the readable medium can be transmitted using any suitable medium, including but not limited to wireless, wired, optical cable, RF, or any suitable combination thereof.

The program code for performing the operations described in the present disclosure can be written in one programming language or any combination of multiple programming languages. The programming language includes object-oriented programming languages such as Java and C++, and includes conventional procedural programming languages such as “C” or similar programming languages. The program code can be executed entirely on the computing device of a user, partially on a device of a user, as a standalone software package, partially on the computing device of a user and partially on a remote computing device, or entirely on a remote computing device or server. In cases involving a remote computing device, the remote computing device can be connected to the computing device of a user via any kind of network, including a local area network (LAN) or a wide area network (WAN), or it can be connected to external computing devices (such as through an Internet service provider over the Internet).

The program product can be implemented using any combination of one or more readable media. The readable media can be either readable signal media or readable storage media. The readable storage media can include, but is not limited to, systems, control devices, or devices using electrical, magnetic, optical, electromagnetic, infrared, or semiconductor systems, or any combination of the above. More specific examples of readable storage media (non-exhaustive list) include devices with one or more wires, electrical connections, portable disks, hard drives, random-access memory (RAM), read-only memory (ROM), erasable programmable read-only memory (EPROM or flash memory), optical fibers, portable compact disc read-only memory (CD-ROM), optical storage devices, magnetic storage devices, or any suitable combination of the above.

The program product for the embodiments of the present disclosure, used for system permission activation, can be implemented using a portable compact disc read-only memory (CD-ROM). It includes program code and can be executed on a computing device. However, the program product for the embodiments of the present disclosure is not limited to this. In the present disclosure, the readable storage medium can be any tangible medium containing or storing a program, and the program can be used by an instruction execution system, a control device, or a device, or combined with it.

The present disclosure is described with reference to flowcharts and/or block diagrams illustrating methods, devices (systems), and computer program products according to embodiments of the present disclosure. It should be understood that each process and/or block in the flowcharts and/or block diagrams can be implemented by computer program instructions, and the combination of processes and/or blocks in the flowcharts and/or block diagrams can be realized by computer program instructions. The provided computer program instructions can be executed by a general-purpose computer, a dedicated computer, an embedded processor, or any processors of other programmable data processing devices to generate a machine that, when the instructions are executed by the processor of the computer or other programmable data processing device, implements the functionality specified in the one or more processes in the flowchart and/or one or more boxes in the block diagram.

These computer program instructions can also be stored in a computer-readable memory that is capable of booting a computer or other programmable data processing device to work in a specific manner. The instructions stored in the computer-readable memory are enabled to generate a product including an instruction apparatus. The instruction apparatus implements the functionality specified in one or more processes in the flowchart and/or one or more boxes in the block diagram.

These computer program instructions can also be loaded onto a computer or another programmable data processing device so as to allow the computer or other programmable device to execute a series of operational steps to produce processing implemented by the computer. The instructions executed on the computer or other programmable device provide steps for implementing the functionality specified in one or more processes in the flowchart and/or one or more boxes in the block diagram.

### CONCLUSION

Disclosed in the present disclosure are a stereoscopic sorting control method, a stereoscopic sorting robot, and a related device. When a first stereoscopic sorting robot has a fault, the first stereoscopic sorting robot unbinds with the target sorting shelves. The state information of other stereoscopic sorting robots is acquired. When the state information indicates that a second stereoscopic sorting robot is in an available and idle state, the second stereoscopic sorting robot is rebound with the target sorting shelves. Therefore, after the stereoscopic sorting robots have a fault, existing idle robots that operate normally are used to rapidly participate in sorting, thereby achieving the technical aim of improving the overall sorting efficiency.

Although preferred embodiments of the present disclosure have been described, once those skilled in the art become aware of the basic inventive concept, they may make additional changes and modifications to these embodiments. Therefore, the appended claims are intended to be construed to include not only the preferred embodiments but also all changes and modifications falling within the scope of the present disclosure.

Clearly, those skilled in the art can make various alterations and modifications to the present disclosure without departing from the spirit and scope of the present disclosure. Thus, if these modifications and variations of the present disclosure fall within the scope of the claims and equivalent technologies, the present disclosure is also intended to include these modifications and variations.

### INDUSTRIAL PRACTICALITY

The present disclosure discloses a stereoscopic sorting control method, a stereoscopic sorting robot, and a related device. The stereoscopic sorting control method can include stereoscopic sorting robots having a binding relationship with identity information of target sorting shelves, wherein the binding relationship is associated with a target order; under a sorting task of the target order, the stereoscopic sorting robots sorting, according to the identity information of the sorting shelves, goods to be sorted; when a first stereoscopic sorting robot has a fault, unbinding the first stereoscopic sorting robot and the target sorting shelves; acquiring state information of other stereoscopic sorting robots, when the state information indicates that a second stereoscopic sorting robot is in an available and idle state; and rebinding the second stereoscopic sorting robot with the target sorting shelves. Therefore, after the stereoscopic sorting robots have a fault, existing idle robots that operate normally are used to rapidly participate in sorting, thereby achieving the technical aim of improving the overall sorting efficiency.

Additionally, it can be understood that the stereoscopic sorting control method, stereoscopic sorting robot, and related device described in the present disclosure are reproducible and can be used in various industrial applications. For example, the stereoscopic sorting control method, the stereoscopic sorting robot, and the related device described in the present disclosure can be used in the technical field of sorting robots.

1. A stereoscopic sorting control method, used for a stereoscopic sorting system, wherein the system comprises multiple stereoscopic sorting robots and sorting shelves, and the stereoscopic sorting control method comprises:
enabling the stereoscopic sorting robots to have a binding relationship with identity information of target sorting shelves, wherein the binding relationship is associated with a target order; under a sorting task of the target order, the stereoscopic sorting robots sorting, according to the identity information of the sorting shelves, goods to be sorted;
when a first stereoscopic sorting robot has a fault, unbinding the first stereoscopic sorting robot and the target sorting shelves;
acquiring state information of other stereoscopic sorting robots; and when the state information indicates that a second stereoscopic sorting robot is in an available and idle state, rebinding the second stereoscopic sorting robot with the target sorting shelves.

2. The stereoscopic sorting control method according to claim 1, wherein the stereoscopic sorting system further comprises one or more flat sorting robots, wherein the flat sorting robots perform a goods delivery to the first stereoscopic sorting robot based on the target order; and
when the first stereoscopic sorting robot has a fault, the method further comprises:
controlling the flat sorting robots to abandon the goods delivery to the first stereoscopic sorting robot;
determining that the target order is re-associated with a rebinding relationship between the second stereoscopic sorting robot and the target sorting shelves; and
controlling the flat sorting robots to initiate a goods delivery to the second stereoscopic sorting robot based on the target order.

3. The stereoscopic sorting control method according to claim 1, wherein the step of acquiring state information of other stereoscopic sorting robots comprises:
determining operational state information and health state information of the multiple stereoscopic sorting robots, wherein the operational state information comprises the idle state, an in-use state, and a standby state; and the health state information comprises a fault state, an available state, and a test state;
determining that the operational state information of a stereoscopic sorting robot is the idle state, and the health state information is the available state, using the stereoscopic sorting robot as an alternative robot for the second stereoscopic sorting robot; and
selecting an optimal robot from multiple alternative stereoscopic sorting robots to serve as the second stereoscopic sorting robot.

4. The stereoscopic sorting control method according to claim 1, wherein after rebinding the second stereoscopic sorting robot with the target sorting shelves, the stereoscopic sorting control method further comprises:
acquiring a sorting state when the first stereoscopic sorting robot has a fault, wherein the sorting state comprises incomplete sorting of the target sorting shelves and incomplete unloading of baskets of the target sorting shelves;
when the target sorting shelves are not completely sorted, binding the second stereoscopic sorting robot with the target sorting shelves; and
when the unloading of the baskets of the target sorting shelves is not completed, placing goods with incomplete unloading onto the second stereoscopic sorting robot.

5. The stereoscopic sorting control method according to claim 3, wherein the step of controlling the flat sorting robots to abandon the goods delivery to the first stereoscopic sorting robot comprises:
the flat sorting robots responding to a fault signal of the first stereoscopic sorting robot acquired by a flat dispatch system;
pausing the goods delivery to the first stereoscopic sorting robot; and
walking along a predetermined path until a binding between the second stereoscopic sorting robot and the target sorting shelves is completed.

6. The stereoscopic sorting control method according to claim 1, wherein the stereoscopic sorting robots have the binding relationship with the identity information of the target sorting shelves, wherein the identity information of the target sorting shelves is realized by the stereoscopic sorting robots using RFID readers, comprising:
reading labels arranged on the target sorting shelves to obtain the identity information, wherein the labels can carry structural data of the sorting shelves and/or location information of basket units, wherein
the structural data of the sorting shelves indicates a longitudinal and transverse structure of the sorting shelves and information about available baskets; and
the location information of the basket units indicates positions of the basket units in a coordinate system formed by the sorting shelves.

7. The stereoscopic sorting control method according to claim 1, wherein the step of the stereoscopic sorting robots sorting, according to the identity information of the sorting shelves, goods to be sorted comprises:
parsing sorting information of the goods to be sorted, wherein the sorting information carries a corresponding relationship with a basket unit in the sorting shelves;
searching a corresponding relationship table to obtain coordinate values of the basket unit in a stereoscopic coordinate system formed by the sorting shelves; and
indexing the coordinate values and locating, to deliver the goods to be sorted to the basket unit.

8. The stereoscopic sorting control method according to claim 1, wherein the stereoscopic sorting system further comprises a control bus, and the step of acquiring state information of other stereoscopic sorting robots comprises:
acquiring state information of other stereoscopic sorting robots on the control bus.

9. A stereoscopic sorting robot, wherein the stereoscopic sorting robot is configured in a stereoscopic sorting system and has a binding relationship with identity information of target sorting shelves, and the binding relationship is associated with a target order; under a sorting task of the target order, the stereoscopic sorting robot sorts, according to the identity information of the sorting shelves, goods to be sorted;
when a first stereoscopic sorting robot has a fault, the first stereoscopic sorting robot unbinds with the target sorting shelves;
a server acquires state information of other stereoscopic sorting robots; and when the state information indicates that a second stereoscopic sorting robot is in an available and idle state, the second stereoscopic sorting robot rebinds with the target sorting shelves.

10. The stereoscopic sorting robot according to claim 9, wherein the stereoscopic sorting system comprises one or more flat sorting robots, wherein the flat sorting robots perform a goods delivery to the first stereoscopic sorting robot based on the target order;
when the first stereoscopic sorting robot has a fault, the flat sorting robots abandon the goods delivery to the first stereoscopic sorting robot and periodically interrogate a state of the target order; and
when the target order is re-associated with a rebinding relationship between the second stereoscopic sorting robot and the target sorting shelves,
the second stereoscopic sorting robot accepts the goods delivery from the flat sorting robots based on the target order.

11. The stereoscopic sorting robot according to claim 9 or 10, wherein
operational state information and health state information of multiple stereoscopic sorting robots are determined, wherein the operational state information comprises the idle state, an in-use state, and a standby state; the health state information comprises a fault state, an available state, and a test state;
when the operational state information of a stereoscopic sorting robot is the idle state and the health state information is the available state, the stereoscopic sorting robot is used as an alternative robot for the second stereoscopic sorting robot; and
a predetermined rule is used to select an optimal robot from multiple alternative stereoscopic sorting robots to serve as the second stereoscopic sorting robot.

12. The stereoscopic sorting robot according to claim 9, wherein the stereoscopic sorting robot has the binding relationship with the identity information of the target sorting shelves, wherein the identity information of the target sorting shelves is realized by the stereoscopic sorting robot using RFID readers in a following method:
reading labels arranged on the target sorting shelves to obtain the identity information, wherein the labels carry structural data of the sorting shelves and/or location information of basket units, wherein
the structural data of the sorting shelves indicates a longitudinal and transverse structure of the sorting shelves and information about available baskets; and
the location information of the basket units indicates positions of the basket units in a coordinate system formed by the sorting shelves.

13. The stereoscopic sorting robot according to any one of claim 9, wherein the stereoscopic sorting robot is arranged in the stereoscopic sorting system via a bus structure.

14. A stereoscopic sorting control system, wherein the stereoscopic sorting control system is configured in the stereoscopic sorting system; and
the stereoscopic sorting control system executes the stereoscopic sorting control method according to claim 1.

15. The stereoscopic sorting control system according to claim 14, wherein the system implements an execution of the stereoscopic sorting control method according to claim 1 through a server in the stereoscopic sorting control system.

16. The stereoscopic sorting control system according to claim 14, wherein the stereoscopic sorting control system is provided with a host computer or central controller to allocate sorting tasks to the stereoscopic sorting robot.

17. (canceled)

18. The stereoscopic sorting control method according to claim 2, wherein the step of acquiring state information of other stereoscopic sorting robots comprises:
determining operational state information and health state information of the multiple stereoscopic sorting robots, wherein the operational state information comprises the idle state, an in-use state, and a standby state; and the health state information comprises a fault state, an available state, and a test state;
determining that the operational state information of a stereoscopic sorting robot is the idle state, and the health state information is the available state, using the stereoscopic sorting robot as an alternative robot for the second stereoscopic sorting robot; and
selecting an optimal robot from multiple alternative stereoscopic sorting robots to serve as the second stereoscopic sorting robot.

19. The stereoscopic sorting control method according to claim 2, wherein after rebinding the second stereoscopic sorting robot with the target sorting shelves, the stereoscopic sorting control method further comprises:
acquiring a sorting state when the first stereoscopic sorting robot has a fault, wherein the sorting state comprises incomplete sorting of the target sorting shelves and incomplete unloading of baskets of the target sorting shelves;
when the target sorting shelves are not completely sorted, binding the second stereoscopic sorting robot with the target sorting shelves; and
when the unloading of the baskets of the target sorting shelves is not completed, placing goods with incomplete unloading onto the second stereoscopic sorting robot.

20. The stereoscopic sorting control method according to claim 4, wherein the step of controlling the flat sorting robots to abandon the goods delivery to the first stereoscopic sorting robot comprises:
the flat sorting robots responding to a fault signal of the first stereoscopic sorting robot acquired by a flat dispatch system;
pausing the goods delivery to the first stereoscopic sorting robot; and
walking along a predetermined path until a binding between the second stereoscopic sorting robot and the target sorting shelves is completed.

21. The stereoscopic sorting control method according to claim 2, wherein the stereoscopic sorting robots have the binding relationship with the identity information of the target sorting shelves, wherein the identity information of the target sorting shelves is realized by the stereoscopic sorting robots using RFID readers, comprising:
reading labels arranged on the target sorting shelves to obtain the identity information, wherein the labels can carry structural data of the sorting shelves and/or location information of basket units, wherein
the structural data of the sorting shelves indicates a longitudinal and transverse structure of the sorting shelves and information about available baskets; and
the location information of the basket units indicates positions of the basket units in a coordinate system formed by the sorting shelves.
